(19) United States
(12) Patent Application Publication
(10) Pub. No.: US 2010/0262884 A1
(43) Pub. Date: Oct. 14, 2010

(54) DIAGNOSTIC SERVER FOR A HOME APPLIANCE AND CONTROLLING METHOD

(76) Inventors: Hyun Sang KIM, Changwon-si (KR); Eui Hyeok Kwon, Changwon-si (KR); Hae Yong Kang, Changwon-si (KR); Yong Tae Kim, Changwon-si (KR); Koon Seok Lee, Changwon-si (KR)

Correspondence Address: KED & ASSOCIATES, LLP, P.O. Box 221200, Chantilly, VA, 20153-1200, US

(21) Appl. No.: 12/757,213

(22) Filed: Apr. 9, 2010

Related U.S. Application Data
(60) Provisional application No. 61/168,368, filed on Apr. 10, 2009.

(30) Foreign Application Priority Data
Apr. 10, 2009 (KR) 10-2009-0031502

(51) Int. Cl. G06F 11/07

(52) U.S. Cl. 714/748; 714/776; 714/E11.023; 714/E11.029

(57) ABSTRACT

A diagnostic server and a controlling method are provided. In the method, the diagnostic server receives a packet including at least one frame and performs error checking on each frame included in the packet. The diagnostic server receives a retransmitted packet upon determining from the result of error checking that a frame in the packet has an error. The diagnostic server performs error checking on each frame included in the retransmitted packet and restores the frame included in the packet based on the retransmitted packet when a frame, which is located in a location corresponding to the error frame, included in the retransmitted packet has no error. In the case where a packet including product information is transmitted, this method can reduce the number of retransmissions of the same packet required to acquire an error-free packet.

### CROSS-REFERENCE TO RELATED APPLICATION

This application claims the benefit of U.S. Patent Application No. 61/168,368 filed on Apr. 10, 2009 in the USPTO, and Korean Patent Application No. 10-2009-0031502, filed on Apr. 10, 2009 in the Korean Intellectual Property Office, the disclosure of which is incorporated herein by reference.

### BACKGROUND OF THE INVENTION

1. Field of the Invention

The present invention relates to a diagnostic server for home appliance and a controlling method, and more particularly to a diagnostic server, which determines product information using a sound signal transmitted from a home appliance, and a controlling method for the diagnostic server, the diagnostic server and the method being designed to receive an error-free packet.

2. Description of the Related Art

Generally, when a failure has occurred in a home appliance while the home appliance is in operation, the user makes a phone call to a service center or the like and explains details of the failure and asks about the cause of the failure.

Although European Patent Application No. EP0510519 describes a technology in which failure information of a home appliance is transmitted to a service center using a telephone network through a modem connected to the home appliance, this technology has a problem in that the modem should always be connected to the home appliance. Especially, connecting a telephone network to a home appliance such as a laundry processing device has spatial limitations since such a home appliance is often installed in an outdoor place such as a porch of a house.

U.S. Pat. No. 5,987,105 describes a technology in which failure information of a home appliance is converted into a sound signal in an audio frequency band and the sound signal is transmitted to a service center or the like through a telephone. The service center may convert a sound signal into data packets and perform error checking on each data packet and analyze product information using an error-free packet. However, this technology has a problem in that, upon determining from the result of the error checking that a packet has an error, the service center should repeatedly receive the same packet until the received packet has no error.

### SUMMARY OF THE INVENTION

Therefore, the present invention has been made in view of the above problems, and it is an object of the present invention to provide a diagnostic server for a home appliance and a controlling method, wherein the diagnostic server receives a packet including product information from a home appliance and performs error checking on each frame included in the packet and restores a frame, in which an error has occurred, using a packet retransmitted from the home appliance.

In accordance with an aspect of the present invention, the above and other objects can be accomplished by the provision of a controlling method for a diagnostic server, the method including receiving a packet including at least one frame, performing error checking on each frame included in the packet, receiving a retransmitted packet upon determining from a result of the error checking that at least one frame in the packet has an error, and performing error checking on each frame included in the retransmitted packet and restoring the frame included in the packet based on the retransmitted packet when a frame, which is located in a location corresponding to the error frame, included in the retransmitted packet has no error.

In accordance with another aspect of the present invention, there is provided a diagnostic server including a transmission/reception unit for receiving a packet including at least one frame, an error checking unit for performing error checking on each frame included in the packet received through the transmission/reception unit, and a main controller for receiving a retransmitted packet upon determining from the error checking of the error checking unit that a frame in the packet has an error and restoring the frame included in the packet based on the retransmitted packet when a frame, which is located in a location corresponding to the error frame, included in the retransmitted packet has no error.

According to the present invention, in the case where a packet including product information is transmitted, it is possible to reduce the number of retransmissions of the same packet required to acquire an error-free packet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a configuration of a home appliance and a diagnostic server according to an embodiment of the present invention;

FIG. 2 is a block diagram illustrating a configuration of a home appliance according to an embodiment of the present invention;

FIG. 3 illustrates a diagnostic server of service center according to an embodiment of the present invention;

FIG. 4 is a flow chart illustrating a method for controlling a diagnostic server of service center according to an embodiment of the present invention; and

FIGS. 5(a) to 5(c) illustrate configurations of packets transmitted to a diagnostic server of service center according to an embodiment of the present invention.

### DETAILED DESCRIPTION OF THE INVENTION

Embodiments of the present invention will now be described with reference to the accompanying drawings.

FIG. 1 illustrates a configuration of a home appliance and a service center according to an embodiment of the present invention. The service center includes a diagnostic server.

As shown in FIG. 1, the home appliance 100 includes an sound output device 160 for outputting a sound signal including product information and outputs an operating status, failure or malfunction information, or the like of the home appliance 100 through the sound output device 160 (S1).

Here, the user checks the product information of the home appliance 100 displayed on the home appliance 100 and controls the operation of the home appliance 100 or requests to the service center 200 to repair the home appliance 100 (S2).

When the user has operated an input unit provided on the home appliance 100 at the request of the service center 200 (S3) after the home appliance 100 is connected to the service center 200, a sound signal including product information is output through the sound output device 160 (S4). By checking this sound signal through an external portable terminal 190, the diagnostic server of the service center 200 can check the product status of the home appliance 100. Here, the home appliance 100 of the present invention does not directly output the product information but instead converts the product information into a sound signal and outputs the sound signal.

The external portable terminal 190 may include a wired/wireless phone or a mobile communication terminal. Generally, a laundry processing device is often installed in an outdoor place such as a porch of a house and it is preferable that a communication device that is easy to move such as a mobile communication terminal be used to receive the sound signal output through the sound output device 160.

Here, it should be noted that the home appliance 100 of the present invention described below may be any home appliance 100 such as a TV, an air conditioner, an electric cooker, or a microwave oven. The service center 200 may be a service center that is applied to any home appliance 100 such as a TV, an air conditioner, an electric cooker, or a microwave oven.

When the home appliance 100 is connected to the service center 200 through a communication network, for example, through a telephone network, the diagnostic server of the service center 200 checks a sound signal output from the home appliance 100 and determines a product status of the home appliance 100 (S5) and dispatches a service technician to the house of the user to provide a service suitable for the product status (S6).

Here, the service center 200 can provide a quick service to the user since the service center 200 deals with the problem of the home appliance 100 after correctly determining the status of the home appliance 100 through the sound signal.

The home appliance 100 is constructed as follows to output product information through a sound signal.

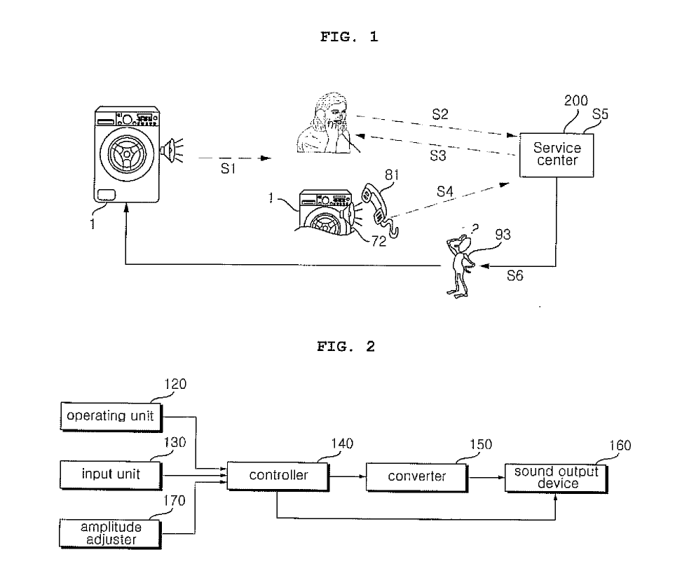

FIG. 2 is a block diagram illustrating a configuration of a home appliance according to an embodiment of the present invention.

As shown in FIG. 2, the home appliance 100 includes an input unit 130 that allows the user to input a signal conversion command, a converter 150 that converts product information into an audio signal, and an sound output device 160 that outputs a sound signal corresponding to the audio signal.

When the user has input the signal conversion command through the input unit 130, a controller 140 controls the converter 150 to convert the product information into the audio signal. Here, the converter 150 converts the product information into the audio signal such that the product information is included in a corresponding packet. The packet includes one or more frames and the controller 140 controls the converter 150 such that each frame includes part or all of the product information. Accordingly, when an error has occurred in a frame of the packet received from the home appliance 100, the diagnostic server of the service center 200 can check the entirety of the product information by restoring only the frame in which an error has occurred.

The sound output device 160 outputs the audio signal generated by the converter 150.

The audio signal is an electrical signal to drive the sound output device 160 and has frequencies. The sound output device 160 outputs a sound signal corresponding to the frequency characteristics of the audio signal. The sound output device 160 may include a buzzer or speaker. The product information includes operation information, failure information, and the like of the product.

The home appliance 100 includes an amplitude adjuster 170 for adjusting the amplitude of the audio signal. That is, the user can set the amplitude of the audio signal through the amplitude adjuster 170. The controller 140 controls the converter 150 to convert the product information into the audio signal according to the set amplitude.

The home appliance 100 also includes the input unit 130 which allows the user to input an output stop command to cause the sound output device 160 to stop outputting the sound signal. When the user has input the output stop command through the input unit 130, the controller 140 causes the converter 150 to stop conversion to stop the sound signal output through the sound output device 160. That is, when the user desires a quiet environment during output of the sound signal of the product information, the user inputs the output stop command through the input unit 130 to stop the output of the sound signal without powering the home appliance 100 off.

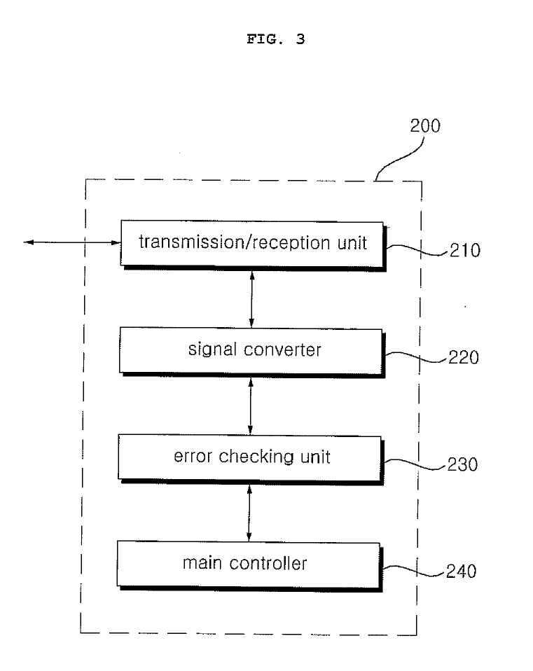

FIG. 3 illustrates the diagnostic server of service center according to an embodiment of the present invention.

As shown in FIG. 3, the diagnostic server of the service center 200 includes a transmission/reception unit 210, a signal converter 220, an error checking unit 230, and a main controller 240.

The transmission/reception unit 210 may receive a sound signal including product information from the external portable terminal 190 and convert the sound signal into an analog signal and transmit the analog signal to the signal converter 220.

The transmission/reception unit 210 may convert a retransmission request signal transmitted from the signal converter 220 into an analog signal and transmit the analog signal to the external portable terminal 190.

The signal converter 220 converts the analog signal transmitted from the transmission/reception unit 210 into digital data and transmits the digital data to the error checking unit 230. The signal converter 220 and the transmission/reception unit 210 may be combined and implemented as a single module.

The error checking unit 230 performs error checking on the digital data produced through conversion by the signal converter 220. The digital data includes one or more packets and each packet includes one or more frames. Although general error checking is performed on a packet by packet basis, the error checking unit 230 according to the present invention performs error checking on frames included in the packet on a frame by frame basis. Error checking may be performed using Cyclic Redundancy Check (CRC). That is, the error checking unit 230 may be replaced with a CRC checker. The error checking unit 230 may perform error checking on each frame using a parity check scheme, a checksum scheme, or an Adler-32 algorithm.

The main controller 240 serves to perform overall control of the diagnostic server of the service center 200 and to read the digital data on which error checking has been performed by the error checking unit 230. That is, according to the result of error checking by the error checking unit 230, the main controller 240 may store and manage the packet and may request, when it is confirmed that an error has occurred in a frame in the packet, that the home appliance 100 retransmit the packet including the frame.

Specifically, upon confirming, from the result of error checking by the error checking unit 230, that an error has occurred in a frame in the packet, the main controller 240 transmits a signal requesting retransmission of the packet including the frame in which an error has occurred. The retransmission request signal is transmitted to the external portable terminal 190 through the signal converter 220 and the transmission/reception unit 210 and the user listens to retransmission request information through a speaker of the external portable terminal 190. The retransmission request information may contain voice information such as “Re-press the send button since data has not been properly sent”.

The main controller 240 includes a general computer system and performs overall control of the diagnostic server and analyzes the data to read the product information and analyzes failure information of the product included in the product information through an operating system stored in the management device storage unit 250.

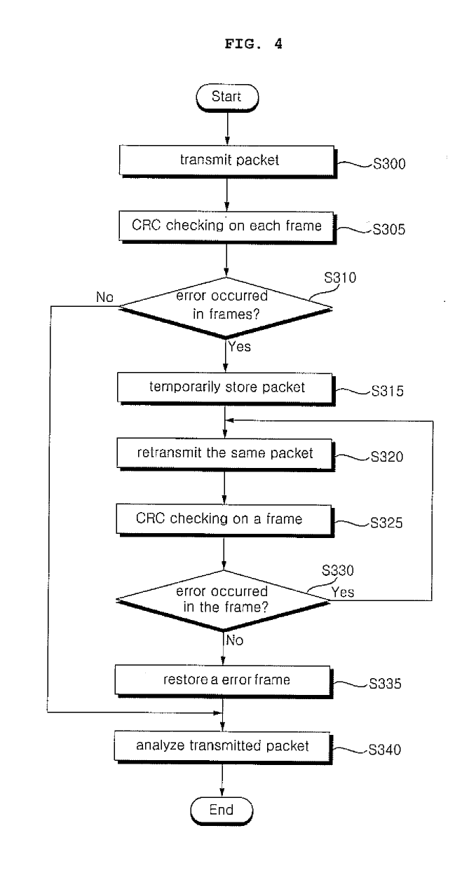

FIG. 4 is a flow chart illustrating a method for controlling the diagnostic server of the service center according to an embodiment of the present invention.

As shown in FIG. 4, first, a sound signal transmitted through the transmission/reception unit 210 is converted into a packet through the signal converter 220 and the packet is then transmitted to the error checking unit 230 (S300).

Then, the error checking unit 230 performs error checking on each frame included in the packet transmitted to the error checking unit 230 (S305). The error checking unit 230 may perform error checking using Cyclic Redundancy Check (CRC). The error checking unit 230 may also perform error checking on each frame using a parity check scheme, a checksum scheme, or an Adler-32 algorithm.

The main controller 240 determines whether or not an error has occurred in any frame in the packet transmitted at step S300 (S310). Upon determining at step S310 that an error has not occurred in any frame in the packet transmitted at step S300, the main controller 240 can obtain product information of the home appliance 100 by analyzing the transmitted packet (S340).

On the other hand, upon determining at step S310 that an error has occurred in a frame in the packet transmitted at step S300, the main controller 240 temporarily stores the transmitted packet (S315). When the main controller 240 has requested retransmission of the same packet as that transmitted at step S300, the same packet is retransmitted to the error checking unit 230 (S320).

Then, the error checking unit 230 performs error checking on each frame included in the packet retransmitted at step S320 (S325). The error checking unit 230 may perform error checking on each frame using CRC, a parity check scheme, a checksum scheme, or an Adler-32 algorithm. Then, from the result of error checking at step S325, the main controller 240 determines whether or not an error has occurred again in a frame, which is located in a location corresponding to the error frame, included in the packet retransmitted at step S320 (S330).

If the first frame in the packet transmitted at step S300 has an error, the main controller 240 determines whether or not an error has occurred again in a first frame included in the packet retransmitted at step S320.

Upon determining at step S330 that an error has not occurred in the first frame in the packet retransmitted at step S320, the main controller 240 restores the first frame in the packet temporarily stored at step S315 using the first frame in the retransmitted packet (S335). Then, the main controller 240 can obtain product information of the home appliance 100 by analyzing the transmitted packet (S340).

On the other hand, in the case where it is determined at step S330 that an error has occurred in the first frame in the packet retransmitted at step S320, the same packet as that retransmitted at step S320 is retransmitted to the error checking unit 230 when the main controller 240 has requested retransmission of the same packet as that retransmitted at step S320 (S320).

That is, error checking is performed on the transmitted packet on a frame by frame basis and, when a first frame in the packet has an error, the same packet is retransmitted and only the first frame included in the transmitted packet is restored based on the retransmitted packet. Accordingly, even when an error has occurred in a second frame in the retransmitted packet, it is possible to restore the first frame without being affected by the occurrence of the error and to obtain an error-free packet without further repeated packet transmission.

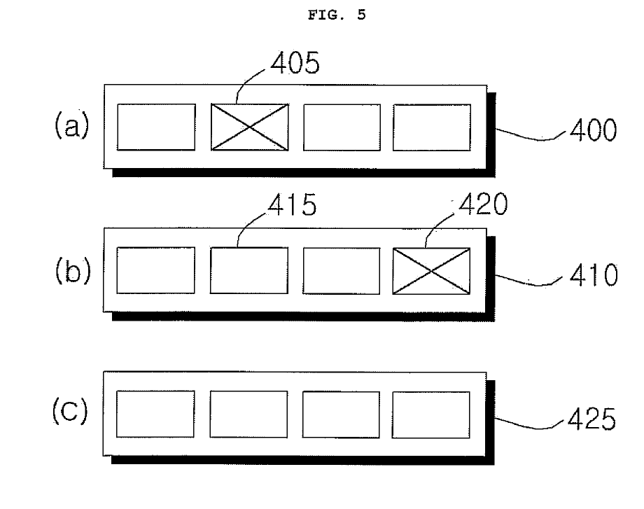

FIGS. 5(a) to 5(c) illustrate configurations of packets that are transmitted to the diagnostic server of service center according to an embodiment of the present invention.

As shown in FIG. 5(a), first, a packet 400 is transmitted through the transmission/reception unit 210. It is confirmed that an error has occurred in a second frame 405 in the transmitted packet. Then, the same packet 410 as the initially transmitted packet 400 is retransmitted as shown in FIG. 5(b). A second frame 415 included in the retransmitted packet 410 has no error while a forth frame 420 included in the retransmitted packet 410 has an error. Accordingly, the main controller 240 can obtain an error-free packet 425 by restoring the second frame of the initially transmitted packet 400 based on the second frame 415 included in the retransmitted packet 410 as shown in FIG. 5(c).

As is apparent from the above description, the diagnostic server of the service center and the method for controlling the same according to the present invention have a variety of advantages. For example, in the case where a packet including product information is transmitted, it is possible to reduce the number of retransmissions of the same packet required to acquire an error-free packet.

Although the diagnostic server for the home appliance and the controlling method for the same according to the present invention have been described with reference to the embodiments and drawings described above, the present invention is not limited to the embodiments and drawings described above and covers all modifications, equivalents, and alternatives falling within the spirit and scope of the invention as defined by the claims.

What is claimed is:

1. A controlling method for diagnostic server, the method comprising:
receiving a packet including at least one frame;
performing error checking on each frame included in the packet;
receiving a retransmitted packet upon determining from a result of the error checking that a frame in the packet has an error; and
performing error checking on each frame included in the retransmitted packet and restoring the frame included in the packet based on the retransmitted packet when a frame, which is located in a location corresponding to the error frame, included in the retransmitted packet has no error.

2. The method according to claim 1, wherein the error checking uses one of Cyclic Redundancy Check (CRC), a parity check scheme, a checksum scheme, and an Adler-32 algorithm.

3. The method according to claim 1, further comprising:
performing error checking on each frame included in the retransmitted packet and again receiving a retransmitted packet when the frame, which is located in a location corresponding to the error frame, included in the retransmitted packet has an error.

4. The method according to claim 1, further comprising:
analyzing the packet upon determining from a result of the error checking that an error is not present in any frame included in the packet.

5. The method according to claim 1, wherein the restoring the frame includes:
even though the other frames included in the retransmitted packet have errors, restoring the frame included in the packet based on the retransmitted packet when the frame, which is located in a location corresponding to the error frame, included in the retransmitted packet has no error,

6. A diagnostic server comprising:
a transmission/reception unit for receiving a packet including at least one frame;
an error checking unit for performing error checking on each frame included in the packet received through the transmission/reception unit; and
a main controller for receiving a retransmitted packet upon determining from the error checking of the error checking unit that a frame in the packet has an error and restoring the frame included in the packet based on the retransmitted packet when a frame, which is located in a location corresponding to the error frame, included in the retransmitted packet has no error.

7. The diagnostic server according to claim 6, wherein the error checking unit performs the error checking using one of Cyclic Redundancy Check (CRC), a parity check scheme, a checksum scheme, and an Adler-32 algorithm.

8. The diagnostic server according to claim 6, wherein the main controller again receives a retransmitted packet through the transmission/reception unit upon determining from the error checking of the error checking unit that the frame, which is located in a location corresponding to the error frame, included in the retransmitted packet has an error.

9. The diagnostic server according to claim 6, wherein the main controller analyzes the packet upon determining from the error checking of the error checking unit that an error is not present in any frame included in the packet.

10. The diagnostic server according to, claim 6, wherein the main controller requests retransmission of the packet through the transmission/reception unit upon determining from the error checking of the error checking unit that the frame included in the packet has an error.
